(19) United States
(12) Patent Application Publication
(10) Pub. No.: US 2014/0180623 A1
(43) Pub. Date: Jun. 26, 2014

(54) SAFETY INSTRUMENT SYSTEM AND PST INITIATING METHOD

(71) Applicant: Azbil Corporation, Tokyo (JP)

(72) Inventor: Kenji OTSUKA, Tokyo (JP)

(73) Assignee: AZBIL CORPORATION, Tokyo (JP)

(21) Appl. No.: 14/140,659

(22) Filed: Dec. 26, 2013

(30) Foreign Application Priority Data
Dec. 26, 2012 (JP) 2012-282328

(51) Int. Cl. F16K 37/00

(52) U.S. Cl. CPC F16K 37/0075
USPC 702/113

(57) ABSTRACT

A safety instrument system includes a plurality of positioners that controls degrees of opening of a plurality of emergency cutoff valves that are provided in pipes in a plant, and a higher-level system that controls PSTs of the emergency cutoff valves. Each positioner comprises a PST executing unit that executes a PST in the emergency cutoff valve in response to an initiating instruction from the higher-level system or an initiating instruction from an inputting device in a workplace wherein the positioner is provided, a PST execution status acquiring unit that acquires PST execution status information for another positioner, and a PST initiation prohibition evaluating unit that evaluates whether or not a PST initiation is permitted, based on a PST execution status of another positioner, when a PST initiating instruction has been received from the higher-level system or from the inputting device.

### CROSS REFERENCE TO RELATED APPLICATION

This application claims priority under 35 U.S.C. §119 to Japanese Patent Application No. 2012-282328, filed on Dec. 26, 2012, the entire content of which being hereby incorporated herein by reference.

### FIELD OF TECHNOLOGY

The present invention relates to a safety instrument system for preserving safety in a plant, and to a PST initiating method.

### BACKGROUND

There are increasing demands for safety instrument systems (hereinafter termed “SIS”) for protecting safety in a plant. In an SIS, and emergency cutoff valve is provided so as to ensure safety by cutting off using the emergency cutoff valve when a failure occurs in the plant. Under normal conditions, the emergency cutoff valve is held in the fully open state, and thus even if the emergency cutoff valve were to become stuck, so as to be in a state that could not function at the time of an emergency, it would be difficult to detect the emergency cutoff valve being stuck.

In order to detect such a fault, periodically a full-closure test of the emergency cutoff valve is performed off-line. The full-closure test must be performed at the time of a periodic inspection when the plant is shut down, and thus is costly. A partial stroke test (PST) is a test that checks the initial motion of the emergency cutoff valve by causing it to move just slightly, while the plant is operating, rather than fully closing the emergency cutoff valve. The time between full-closure tests can be extended through PSTs, thus reducing the preventive maintenance expense. See, for example, NISHIDA, June: “Newest Trends in Safety Instrument Systems: PST Solutions and General Solutions,” Instrumentation 2006, Volume 49, No. 11, Kogyogijutsusha, 2006.

A safety instrument is controlled through PFD (Probability of Failure on Demand). The effect of the PST is that it is possible to extend the time between full-closure tests without changing the average value of the PFD between full-closure tests of the emergency cutoff valve. In order to keep the average value of the PFD to a planned value, it is necessary to perform the PSTs following a plan that is scheduled in advance. On the other hand, it is necessary to perform the PST while visually confirming the action of the emergency cutoff valve in the plant. In the technology described in Japanese Patent 4121378 (“the JP '378”), a method is proposed for initiating a PST from the plant floor through a switch, or the like.

When a PST is executed there is an effect, albeit small, on the flow rate of the fluid flows through the emergency cutoff valve. Because of this, in the conventional technology disclosed in the JP '378, when PSTs are executed simultaneously on a large number of emergency cutoff valves, it is possible that the adverse effect (the disruption) on the state of production of the product that is produced by the plant may be greater than anticipated.

The present invention was created to solve the problems set forth above, and an aspect thereof is to provide a safety instrument system and a PST initiating method able to prevent their from being a larger disruption than anticipated through simultaneous PST initiations.

### SUMMARY

A safety instrument system according to the present invention includes a plurality of positioners that controls the degrees of opening of a plurality of emergency cutoff valves that are provided in pipes in a plant, and a higher-level system that controls the PSTs of the emergency cutoff valves. Each positioner includes a PST executing unit that executes a PST in the emergency cutoff valve in response to an initiating instruction from the higher-level system or an initiating instruction from an inputting device in the workplace wherein the positioner is provided, a PST execution status acquiring unit that acquires PST execution status information for another positioner, a PST initiation prohibition evaluating unit that evaluates whether or not a PST initiation is permitted, based on a PST execution status of another positioner, when a PST initiating instruction has been received from the higher-level system or from the inputting device.

A safety instrument system according to the present invention includes a plurality of positioners that controls the degrees of opening of a plurality of emergency cutoff valves that are provided in pipes in a plant, and a higher-level system that controls PSTs of the emergency cutoff valves. Each positioner includes a querying unit that queries the higher-level system as to whether or not PST initiation is permitted, when a PST initiating instruction has been received from the inputting device in the work area where in the positioner is provided, and a PST executing unit that executes a PST in the emergency cutoff valve in response to an initiating instruction from the higher-level system and executes a PST in the emergency cutoff valve through an initiating instruction from an inputting device in response to a PST initiation permitted/prohibited report from the higher-level system. The higher-level system includes a storage unit that stores a schedule for PSTs, established in advance, a PST initiation instructing unit that sends, to the positioner, a PST initiating instruction following the schedule stored in the storage unit, a PST execution status acquiring unit that acquires PST execution status information for each positioner, a PST initiation prohibition evaluating unit that evaluates whether or not to permit PST initiation based on the execution statuses of the PSTs of each of the positioners when there has been a query from a positioner as to whether or not PST initiation is permitted, reports to the positioner, and evaluates whether or not to permit PST initiation based on the execution statuses of the PSTs of each of the positioners when PST initiation timing has been reached based on the schedule, and, if PST initiation is permitted, instructs the PST initiation instructing unit to send a PST initiating instruction to the positioner.

A safety instrument system according to the present invention includes a plurality of positioners that controls the degrees of opening of a plurality of emergency cutoff valves that are provided in pipes in a plant, a plurality of flow rate measuring instruments that measures flow rates of the process fluids that flow through the individual emergency cutoff valves, and a higher-level system that controls PSTs of the emergency cutoff valves. Each positioner includes a PST executing unit that executes a PST in the emergency cutoff valve in response to an initiating instruction from the higher-level system or an initiating instruction from an inputting device in the workplace wherein the positioner is provided, a PST execution status acquiring unit that acquires PST execution status information for another positioner, a flow rate measurement value acquiring unit that acquires the flow rate measurement value from the corresponding flow rate measuring instrument, and a PST initiation prohibition evaluating unit that evaluates whether or not a PST initiation is permitted, based on a PST execution status of another positioner, and on the flow rate of the process fluid flowing through the corresponding emergency cutoff valve, when a PST initiating instruction has been received from the higher-level system or from the inputting device.

A safety instrument system according to the present invention includes a plurality of positioners that controls the degrees of opening of a plurality of emergency cutoff valves that are provided in pipes in a plant, a plurality of flow rate measuring instruments that measures flow rates of the process fluids that flow through the individual emergency cutoff valves, and a higher-level system that controls PSTs of the emergency cutoff valves. Each positioner includes a querying unit queries the higher-level system as to whether or not PST initiation is permitted, when a PST initiating instruction has been received from the inputting device in the work area where in the positioner is provided, and a PST executing unit that executes a PST in the emergency cutoff valve in response to an initiating instruction from the higher-level system and executes a PST in the emergency cutoff valve through an initiating instruction from an inputting device in response to a PST initiation permitted/prohibited report from the higher-level system. The higher-level system includes a storage unit that stores a schedule for PSTs, established in advance, a PST initiation instructing unit that sends, to the positioner, a PST initiating instruction following the schedule stored in the storage unit, a PST execution status acquiring unit that acquires PST execution status information for each positioner, a flow rate measurement value acquiring unit that acquires flow rate measurement values from each of the flow rate measuring instruments, and a PST initiation prohibition evaluating unit that evaluates whether or not to permit PST initiation based on the execution statuses of the PSTs of each of the positioners and the flow rate of the process fluid flowing through the emergency cutoff valve corresponding to the positioner that made the query when there has been a query from a positioner as to whether or not PST initiation is permitted, reports to the positioner, and evaluates whether or not to permit PST initiation based on the execution statuses of the PSTs of each of the positioners and the flow rate of the process fluid flowing through the emergency cutoff valve corresponding to the positioner that reached the PST initiation timing when PST initiation timing has been reached based on the schedule, and, if PST initiation is permitted, instructs the PST initiation instructing unit to send a PST initiating instruction to the positioner.

In the first configuration of a safety instrument system according to the present invention: the higher-level system includes the PST initiation prohibition evaluating unit which, when there is a query from the positioner as to whether or not PST initiation is permitted, evaluates whether or not PST initiation is permitted based on the PST execution statuses of each of the positioners and on whether or not a positioner that is executing a PST belongs to the same system of pipes as the positioner of the query, reports to the positioner, and when PST initiation timing based on the schedule has been reached, and the PST initiation prohibition evaluating unit which evaluate whether or not PST initiation is permitted based on the PST execution statuses of the individual positioners and on whether or not a positioner that is executing a PST belongs to the same system of pipes as the positioner corresponding to the emergency cutoff valve that has reached the PST initiation timing, and if PST initiation is permitted, instructs the PST initiation instructing units to send a PST initiating instruction to the positioner.

A PST initiating method according to the present invention includes a PST initiation prohibition evaluating step for acquiring PST execution status information for other positioners and for evaluating whether or not a PST initiation is permitted, based on the PST execution statuses of the other positioners, when a PST initiating instruction has been received by a positioner, for controlling the opening of an emergency cutoff valve that is provided in a pipe in a plant, from a higher-level system that manages PSTs on the emergency cutoff valve or from an inputting device on the plant floor wherein the positioner is provided, and a PST executing step wherein the positioner executes a PST on the emergency cutoff valve when PST initiation is permitted.

Moreover, a PST initiating method according to the present invention includes a querying step for querying the higher-level system that manages PSTs on the emergency cutoff valve as to whether or not PST initiation is permitted, when the positioner that controls the degree of opening of the emergency cutoff valve that is provided in a pipe in a plant has received a PST initiating instruction for the emergency cutoff valve from the inputting device in the work area where in the positioner is provided, a PST executing step wherein the positioner executes a PST in the emergency cutoff valve in response to an initiating instruction from the higher-level system and for executing a PST in the emergency cutoff valve through an initiating instruction from an inputting device in response to a PST initiation permitted/prohibited report from the higher-level system, a first PST initiation prohibition evaluating step for acquiring PST execution status information for other positioners, for evaluating whether or not a PST initiation is permitted, based on the PST execution statuses of the other positioners, and for reporting to the positioner, when there has been a query from the positioner as to whether or not PST initiation is permitted, and a second PST initiation prohibition evaluating step wherein the higher-level system acquires PST execution status information for each of the positioners, evaluates whether or not PST initiation is permitted, based on the PST execution statuses of the individual positioners, and, if PST initiation is permitted, sends a PST initiating instruction to the positioner, if timing for a PST initiation has been reached based on the schedule.

Moreover, a PST initiating method according to the present invention includes a PST initiation prohibition evaluating step for acquiring PST execution status information for other positioners and for acquiring a flow rate measurement value from a flow rate measuring instrument for measuring a flow rate of a process fluid through a corresponding emergency cutoff valve, and for evaluating whether or not a PST initiation is permitted, based on the PST execution statuses of the other positioners and on a flow rate of a process fluid through a corresponding emergency cutoff valve, when a PST initiating instruction has been received by a positioner, for controlling the opening of an emergency cutoff valve that is provided in a pipe in a plant, from a higher-level system that manages PSTs on the emergency cutoff valve or from an inputting device on the plant floor wherein the positioner is provided, and a PST executing step wherein the positioner executes a PST on the emergency cutoff valve when PST initiation is permitted.

Moreover, a PST initiating method according to the present invention includes a querying step for querying the higher-level system that manages PSTs on the emergency cutoff valve as to whether or not PST initiation is permitted, when the positioner that controls the degree of opening of the emergency cutoff valve that is provided in a pipe in a plant has received a PST initiating instruction for the emergency cutoff valve from the inputting device in the work area where in the positioner is provided, a PST executing step wherein the positioner executes a PST in the emergency cutoff valve in response to an initiating instruction from the higher-level system and for executing a PST in the emergency cutoff valve through an initiating instruction from an inputting device in response to a PST initiation permitted/prohibited report from the higher-level system, a first PST initiation prohibition evaluating step for acquiring PST execution status information for other positioners and for acquiring a flow rate measurement value from a flow rate measuring instrument for measuring a flow rate of a process fluid through a corresponding emergency cutoff valve, and for evaluating whether or not a PST initiation is permitted, based on the PST execution statuses of the other positioners and on a flow rate of a process fluid through a corresponding emergency cutoff valve, and for reporting to the positioner, when there has been a query from the positioner as to whether or not PST initiation is permitted, and a second PST initiation prohibition evaluating step for acquiring PST execution status information for other positioners and for acquiring a flow rate measurement value from a flow rate measuring instrument for measuring a flow rate of a process fluid through a corresponding emergency cutoff valve, for evaluating whether or not a PST initiation is permitted, based on the PST execution statuses of the other positioners and on a flow rate of a process fluid through an emergency cutoff valve for which the PST initiation timing has been reached, and for sending, to the positioner, a PST initiating instruction if PST initiation is permitted, when a PST initiation timing has been reached based on a schedule.

In the first configuration of the PST initiating method according to the present invention, the first PST initiation prohibition evaluating step, when there has been a query from the positioner as to whether or not PST initiation is permitted, evaluates whether or not a PST initiation is permitted, based on the PST execution statuses of each of the positioners and on whether or not a positioner that is executing a PST belongs to the same system of pipes as the positioner that made the query, and reports to the positioner, and the second PST initiation prohibition evaluating step, if timing for a PST initiation has been reached based on the schedule, evaluates whether or not PST initiation is permitted based on the PST execution statuses of the individual positioners and on whether or not a positioner that is executing a PST belongs to the same system of pipes as the positioner corresponding to the emergency cutoff valve for which the PST initiation timing has been reached, and, if PST initiation is permitted, sends a PST initiating instruction to the positioner.

With the present invention, when the positioner has received a PST initiating instruction from a higher-level system or from an inputting device, whether or not PST initiation is permitted is evaluated based on the state of execution of PSTs on other positioners, thus making it possible to prevent simultaneous execution of multiple PSTs, making it possible to suppress a larger-than-anticipated disruption to the plant that would result from simultaneous execution of multiple PSTs.

Moreover, with the present invention, when there is a query from a positioner as to whether or not PST initiation is permitted, or when the timing for PST initiation has been reached, whether or not PST initiation is permitted is evaluated based on the state of execution of PSTs of various positioners, thus making it possible to prevent simultaneous execution of multiple PSTs, making it possible to suppress a larger-than-anticipated disruption to the plant that would result from simultaneous execution of multiple PSTs.

Moreover, with the present invention, when the positioner has received a PST initiating instruction from a higher-level system or from an inputting device, whether or not PST initiation is permitted is evaluated based on the state of execution of PSTs on other positioners and on the flow rates of the process fluid that flows through the corresponding emergency cutoff valves, thus making it possible to relax the PST initiation prohibition conditions, and is possible to avoid excessive suppression of PSTs.

Moreover, with the present invention, when there is a query from a positioner as to whether or not a PST initiation is permitted, the higher-level system evaluates whether or not PST initiation is permitted, based on the PST execution statuses of the individual positioners and on the flow rate of the process fluid that flows through the emergency cutoff valve corresponding to the positioner that made the query, and if the PST initiation timing has been reached based on the schedule, the higher-level system evaluates whether or not PST initiation is permitted, based on the PST initiation statuses of the individual positioners and the flow rate of the process fluid flowing through the emergency cutoff valve that has reached the PST initiation timing, thus making it possible to relax the PST initiation prohibiting conditions, making it possible to avoid overly suppressing the PSTs.

Moreover, with the present invention, when there is a query from a positioner as to whether or not a PST initiation is permitted, the higher-level system evaluates whether or not PST initiation is permitted, based on the PST execution statuses of the individual positioners and on whether or not the positioner that is executing the PST belongs to the same system of pipes as the positioner that made the query, and if the PST initiation timing has been reached based on the schedule, the higher-level system evaluates whether or not PST initiation is permitted, based on the PST initiation statuses of the individual positioners and on whether or not the positioner that is executing the PST belongs to the same system of pipes as the positioner corresponding to the emergency cutoff valve that has reached the PST initiation timing, thus making it possible to relax the PST initiation prohibiting conditions, making it possible to avoid overly suppressing the PSTs.

BRIEF DESCRIPTIONS OF THE DRAWINGS

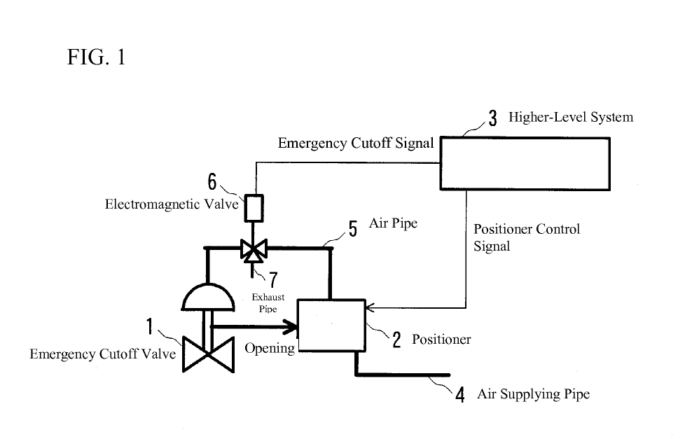

FIG. 1 is a block diagram illustrating a structure for a safety instrument system according to Example according to the present invention.

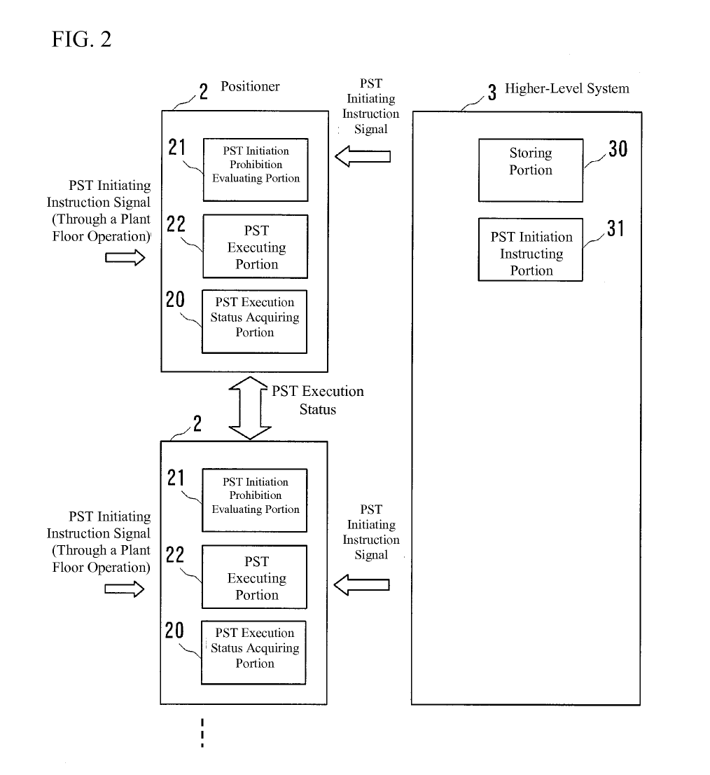

FIG. 2 is a block diagram illustrating a structure for a positioner and a higher-level system in the safety instrument system according to the Example according to the present invention.

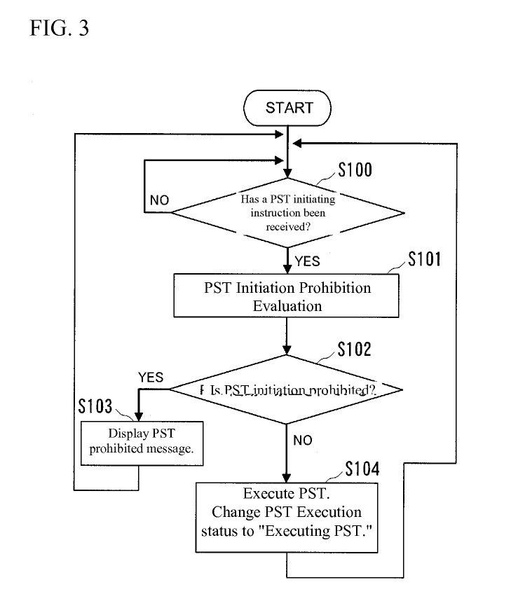

FIG. 3 is a flowchart illustrating the operation of the safety instrument system according to the Example according to the present invention.

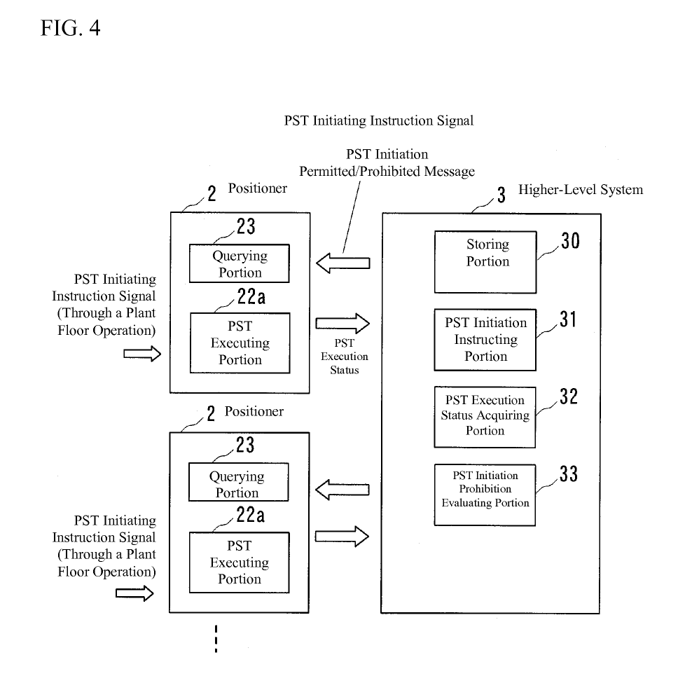

FIG. 4 is a block diagram illustrating a structure for a positioner and a higher-level system in the safety instrument system according to Another Example according to the present invention.

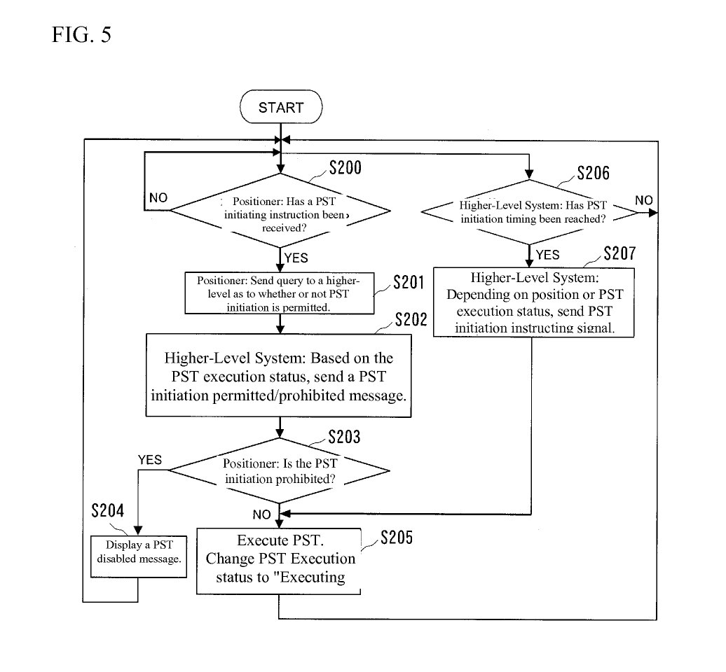

FIG. 5 is a flowchart illustrating the operation of the safety instrument system according to the Another Example according to the present invention.

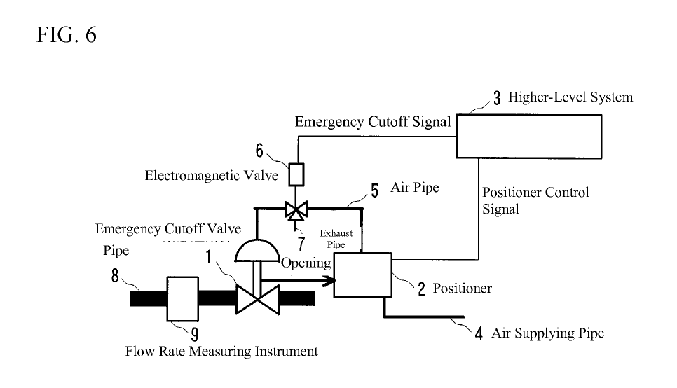

FIG. 6 is a block diagram illustrating a structure for a safety instrument system according to Yet Another Example according to the present invention.

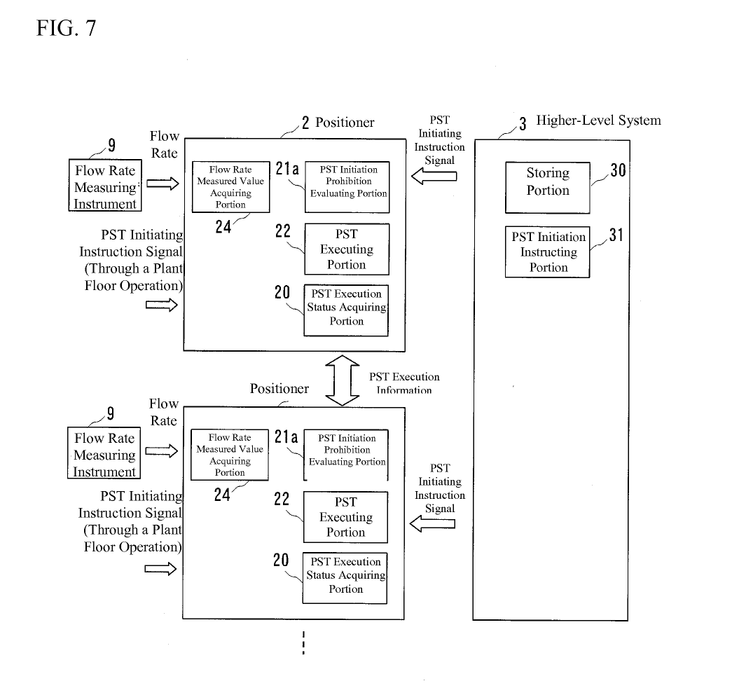

FIG. 7 is a block diagram illustrating a structure for a positioner and a higher-level system in the safety instrument system according to the Yet Another Example according to the present invention.

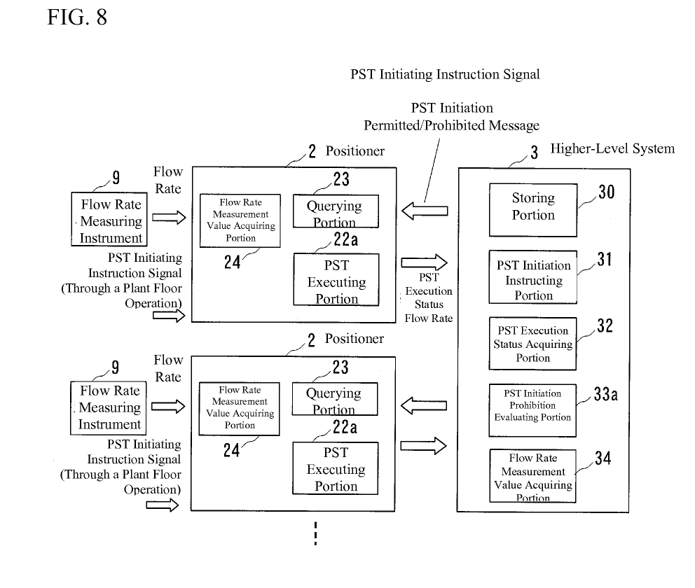

FIG. 8 is a block diagram illustrating a structure for a positioner and a higher-level system in the safety instrument system according to Further Example according to the present invention.

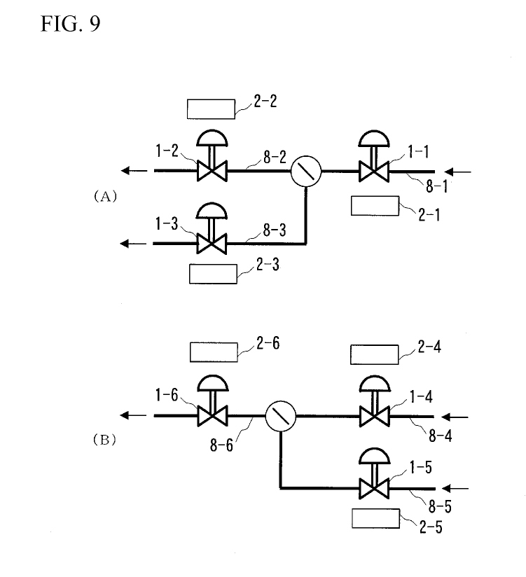

FIG. 9 is a diagram illustrating an example of piping in the plant.

### DETAILED DESCRIPTION

In the present invention, the communication functions that are provided in the positioners are used so as to operate to prevent simultaneous execution of PSTs by multiple positioners. As a result, it is possible to reduce problems caused by unlimited PST initiation on the plant floor while maintaining flexibility for PST initiation depending on the situation on the plant floor.

Examples according to the present invention will be explained below in reference to the drawings. However, any one of the examples explained below is no more than an illustration, and does not exclude various modifications and applications to technologies not explicated below. That is, the present invention can be embodied in a variety of modified forms, in the scope that does not deviate from the spirit and intent thereof.

### EXAMPLE

FIG. 1 is a block diagram illustrating a structure for a safety instrument system according to Example according to the present invention.

An emergency cutoff valve 1 that is provided in order to prevent an incident in a plant is provided in a pipe in the plant and is driven pneumatically. A positioner 2 that controls the opening of the emergency cutoff valve 1 receives a positioner control signal from a higher-level system 3 that controls the maintenance of the various field devices in the plant, and, in response to an opening instruction value indicated by the positioner control signal, uses air that is supplied from an air supplying pipe 4 to send the required operating device air pressure to the emergency cutoff valve 1. The operating device air pressure from the positioner 2 is provided to the emergency cutoff valve 1 through an air pipe 5. Moreover, the positioner 2 is able to measure the degree of opening of the emergency cutoff valve 1 through an opening feedback mechanism.

At the time of an emergency cutoff, triggered by a fault in the plant, the emergency cutoff signal is sent from the higher-level system 3 to an electromagnetic valve 6 that is provided in the air pipe 5 between the positioner 2 and the emergency cutoff valve 1. In response to the emergency cutoff signal, the electromagnetic valve 6 opens the path of the air pipe 5 toward the air exhaust pipe 7, to release the operating device air pressure. The emergency cutoff valve 1 is closed thereby.

When a PST is executed, the degree of opening of the emergency cutoff valve 1 is varied, by the positioner 2, as, for example, 100%→90% →100%, making it possible to confirm the initial action of the emergency cutoff valve 1. The PST may be initiated by a positioner control signal from the higher-level system 3, and may also be initiated through a control panel, or the like, that is an inputting device that is provided on the positioner 2. One emergency cutoff valve 1 of this type, or a plurality thereof, is provided in the plant.

FIG. 2 is a block diagram illustrating a structure of a positioner 2 and a higher-level system 3 according to the present example. In the present example, a function for evaluating whether or not to initiate the PST is provided within the positioner 2.

A positioner 2 is provided for each emergency cutoff valve. Note that the present example envisions a case wherein a plurality of emergency cutoff valves is provided in the same system of pipes. Each positioner 2 includes a PST execution status acquiring portion 20 for acquiring information on PST execution statuses of other positioners 2, a PST initiation prohibition evaluating portion 21 for evaluating whether or not PST initiation is permitted for a corresponding emergency cutoff valve 1, and a PST executing portion 22 for performing a PST on the corresponding emergency cutoff valve 1, and for evaluating PST completion, for performing fault evaluation on the emergency cutoff valve 1. The positioner 2 is able to receive both a PST initiating instruction signal that is inputted from an operating panel that is an inputting device, not shown, and a PST initiating instruction signal that is sent from the higher-level system 3.

The higher-level system 3 includes a storing portion 30 for storing, for each emergency cutoff valve, a PST schedule that has been established in advance, and a PST initiation instructing portion 31 for initiating PSTs in accordance with the schedule.

The operation of the safety instrument system of the present example will be explained below in reference to FIG. 3. Following a schedule that is stored in the storing potion 30, the PST initiation instructing portion 31 of the higher-level system 3 periodically sends PST initiating instruction signals, for the individual emergency cutoff valves 1 to the corresponding positioners 2.

When a PST initiation prohibition evaluating portion 21 of an individual positioner 2 receives a PST initiating instruction signal from the operating panel of the positioner 2 or from the higher-level system 3 (YES in Step S100 in FIG. 3), PST execution status information of the other positioners 2 is acquired through a PST execution status acquiring portion 20, to evaluate whether or not the initiation of the PST on the corresponding emergency cutoff valve 1 is to be prohibited (Step S101 in the FIG. 3).

If a PST is being executed on another positioner 2, then the PST initiation prohibition evaluating portion 21 prohibits the initiation of a PST on the corresponding emergency cutoff valve 1 (YES in Step S102 of FIG. 3). Given this, the PST initiation prohibition evaluating portion 21 causes the display, on an outputting device such as the operating panel of the positioner 2, of a message to the effect that initiation of the PST is prohibited (Step S103 in FIG. 3). Conversely, the PST initiation prohibition evaluating portion 21 may send the message to the effect that initiation of the PST is prohibited to the higher-level system 3. In this case, the message is displayed on a display screen of the higher-level system 3.

Moreover, when there is no other positioner 2 that is executing a PST, the PST initiation prohibition evaluating portion 21 permits the initiation of a PST on the corresponding emergency cutoff valve 1 (NO in Step S102 in FIG. 3), and causes the PST executing portion 22 to execute the PST (Step S104 in FIG. 3). As described above, the PST executing portion 22 varies the opening of the emergency cutoff valve 1 as, for example, 100%→90%→100%, and checks the action of the emergency cutoff valve 1. As a result, the PST execution status of the positioner 2 that is executing the PST is changed to “PST executing.” Although not illustrated in FIG. 3, at the point in time that the PST is completed, the PST execution status, of course, changes to “PST standby.”

As described above, when, in the present example, a PST is being executed on another positioner 2 belonging to the piping of the same system, the initiation of the PST is not permitted, thereby making it possible to suppress a larger-than-anticipated disruption to the plant that would result from simultaneous execution of multiple PSTs.

### Another Example

Another Example according to the present invention will be explained next. FIG. 4 is a block diagram illustrating a structure of a positioner 2 and a higher-level system 3 according to the present example. In the present example as well, the overall structure of the safety instrument system is identical to that of the Example, and thus the explanation will use the codes of FIG. 1. In the Example, evaluations as to whether or not to permit PST initiation were performed by positioners 2 individually. On the other hand, in the present example the higher-level system 3 acquires PST execution status information for the positioners 2, to evaluate, based on this information, whether or not the PST initiations are permitted. As with the Example, the present example envisions a case wherein a plurality of emergency cutoff valves is provided in the same system of pipes.

The higher-level system 3 includes a storing portion 30, a PST initiation instructing portion 31, a PST execution status acquiring portion 32 for acquiring PST initiation status information of the individual positioners 2, and a PST initiation prohibition evaluating portion 33 for evaluating whether or not PST initiation is permitted for each of the individual emergency cutoff valves 1. In addition to the PST initiating instruction signals, signals for providing notification as to whether or not a PST initiation is permitted (PST initiation permitted/prohibited messages) are sent to the individual positioners 2 from the higher-level system 3.

Each positioner 2 includes a PST executing portion 22a for executing a PST on the corresponding emergency cutoff valve 1 in response to a PST initiation permitted/prohibited message that is sent from the higher-level system 3, and a querying portion 23 for sending a query to the higher-level system 3 as to whether or not PST initiation is permitted when a PST initiation instructing signal is received from an operating panel. As with the Example, each positioner 2 is able to receive both a PST initiating instruction signal that is inputted from an operating panel that is an inputting device on the plant floor, and a PST initiating instruction signal that is sent from the higher-level system 3.

The operation of the safety instrument system of the present example will be explained below in reference to FIG. 5. When a PST initiating instruction signal has been received from an operating panel of an individual positioner 2 (YES in Step S200 of FIG. 5), the querying portion 23 of the positioner 2 queries the higher-level system 3 as to whether or not the initiation of a PST is permitted (Step S201 in FIG. 5).

When a query is received from a positioner 2, the PST initiation prohibition evaluating portion 33 of the higher-level system 3 acquires PST execution status information for each of the positioners 2 through the PST execution status acquiring portion 32, and evaluates whether or not PST initiation is permitted for the positioner 2 that made the query, and sends the evaluation result to the positioner 2 that made the query (Step S202 in FIG. 5). If there is a positioner 2 wherein a PST is being performed, the PST initiation prohibition evaluating portion 33 sends a PST evaluation prohibiting message, and if there is no positioner 2 that is performing a PST, it sends a PST initiation permitting message.

When a PST initiation prohibiting message is received from the higher-level system 3 (YES in Step S203 of FIG. 5), the PST executing portion 22a of the positioner 2 that made the query to the higher-level system 3 causes a message to the effect that the PST initiation is prohibited to be displayed on an outputting device, such as the operating panel, of the positioner 2 (Step S204 in FIG. 5).

Moreover, if a PST initiation permitting message is received from the higher-level system 3 (NO in Step S203 of FIG. 5), the PST executing portion 22a executes the PST on the corresponding emergency cutoff valve 1 (Step S205 in FIG. 5). As a result, the PST execution status of the positioner 2 that is executing the PST is changed to “PST executing.” Although not illustrated in FIG. 5, at the point in time that the PST is completed, the PST execution status, of course, changes to “PST standby.”

On the other hand, the PST initiation prohibition evaluating portion 33 references the schedule that is stored in the storing portion 30, and if the evaluation is that the PST initiation timing has been reached for a given emergency cutoff valve 1 (YES in Step S206 in FIG. 5), it acquires the PST execution status information of the individual positioners 2 through the PST execution status acquiring portion 32, to evaluate whether or not to permit the initiation of the PST on the emergency cutoff valve 1 (Step S207 in FIG. 5). If there is a positioner 2 where a PST is being executed, then the PST initiation prohibition evaluating portion 33 prohibits the initiation of the PST. Moreover, if there is no positioner 2 that is executing a PST, the PST initiation prohibition evaluating portion 33 permits the initiation of the PST, and instructs the PST initiation instructing portion 31 to send the PST initiating instruction signal. In response to this instruction, the PST initiation instructing portion 31 sends a PST initiating instruction signal to the positioner 2 corresponding to the emergency cutoff valve 1 that has reached the timing for initiating the PST.

The PST executing portion 22a of the individual positioner 2, upon receipt of a PST initiating instruction signal from the higher-level system 3, executes a PST on the corresponding emergency cutoff valve 1.

Consequently, it is possible to reduce problems caused by unlimited PST initiation on the individual plant floors while maintaining flexibility for PST initiation depending on the situation on the plant floor, through using the communication functions that are provided in the positioners 2 so as to operate to prevent simultaneous execution of PSTs by multiple positioners 2. The Example applied to a relatively few, that is 2 or 3, positioners 2 for which simultaneous execution of PSTs is to be avoided. On the other hand, the present example applies to the case wherein the scope of the plant is large, in a design that combines prohibition of simultaneous PST execution for a large number of positioners 2.

### Yet Another Example

Yet Another Example according to the present invention will be explained next. The Example and Another Example were examples wherein simply simultaneous execution of PSTs was prohibited. However, there is the potential for excessively suppressing plant floor evaluations because even cases wherein there would be an adverse effect through simultaneous PST execution are subject to prohibition. The action of the PST is an action that reduces the flow rate for the fluid that flows through the emergency cutoff valve, and thus there are many cases wherein it is possible to specify in advance a range over which the effect of the PST on the pre-PST initiation fluid flow rate would not be a problem. Consequently, by setting, based on the flow rate, a limited range wherein PST initiation is not prohibited it is possible to relax excessive suppression of PSTs.

FIG. 6 is a block diagram illustrating a structure of a safety instrument system according to the present example, where structures identical to those of FIG. 1 are assigned identical codes. In the safety instrument system according to the present example, flow rate measuring instruments 9, for measuring flow rates of the process fluids that pass through the emergency cutoff valves 1 near the emergency cutoff valves 1 that are provided in the plant piping 8 are added to the structure in the Example that is illustrated in FIG. 1. A flow rate measuring instrument 9 is provided for each emergency cutoff valve.

The positioner 2 is able to monitor, through some means, the measurement result of the flow rate measuring instrument 9. As specific means, one may consider means for receiving analog measurement signals from the flow rate measuring instrument 9, or means for receiving digital measurement data through a DCS (Distributed Control System). As with the Example, the present example envisions a case wherein a plurality of emergency cutoff valves is provided in the same system of pipes.

FIG. 7 is a block diagram illustrating a structure of a positioner 2 and a higher-level system 3 according to the present example, where structures identical to those of FIG. 2 are assigned identical codes. The higher-level system 3 includes a storing portion 30, a PST initiation instructing portion 31. Each positioner 2 includes a PST execution status acquiring portion 20, a PST initiation prohibition evaluating portion 21a, a PST executing portion 22, and a flow rate measurement value acquiring portion 24 for acquiring a flow rate measurement value for the process fluid from the flow rate measuring instrument 9. As with the Example, each positioner 2 is able to receive both a PST initiating instruction signal that is inputted from an operating panel that is an inputting device on the plant floor, and a PST initiating instruction signal that is sent from the higher-level system 3.

In the present example, the flow of processes of the controlling device is identical to that in the Example, so FIG. 3 will be used to explain the operation of the safety instrument system according to the present example.

When a PST initiation prohibition evaluating portion 21a of an individual positioner 2 receives a PST initiating instruction signal from the operating panel of the positioner 2 or from the higher-level system 3 (YES in Step S100 in FIG. 3), PST execution status information of the other positioners 2 is acquired through a PST execution status acquiring portion 20, and a flow rate measurement value is acquired from the corresponding flow rate measuring instrument 9 through the flow rate measurement value acquiring portion 24, to evaluate whether or not the initiation of the PST on the corresponding emergency cutoff valve 1 is to be prohibited (Step S101 in the FIG. 3).

If a PST is being executed on another positioner 2, the PST initiation prohibition evaluating portion 21 a checks the flow rate measurement value acquired from the flow rate measuring instrument 9, and prohibits the initiation of a PST on the corresponding emergency cutoff valve 1 if the current flow rate of the process fluid that flows through the corresponding emergency cutoff valve 1 is outside of a specified range (YES in Step S102 of FIG. 3). Given this, the PST initiation prohibition evaluating portion 21 either causes the display, on an outputting device such as the operating panel of the positioner 2, of a message to the effect that initiation of the PST is prohibited, or sends, to the higher-level system 3, a message to the effect that the PST is prohibited (Step S103 in FIG. 3).

Moreover, when there is no other positioner 2 that is executing a PST, or if another positioner 2 is executing a PST and the current process fluid that flows in the corresponding emergency cutoff valve 1 is within a specified range, the PST initiation prohibition evaluating portion 21a permits the initiation of a PST on the corresponding emergency cutoff valve 1 (NO in Step S102 in FIG. 3), and causes the PST executing portion 22 to execute the PST (Step S104 in FIG. 3).

As described above, in the present example the addition, to the evaluation criteria, of the flow rate of the process fluid that flows through the emergency cutoff valve 1 makes it possible to permit PST initiation in cases wherein the flow rate of the process fluid that flows through the corresponding emergency cutoff valve 1 is within the specified range, even if there is another positioner 2, belonging to the same system of pipes, that is executing a PST, thus making it possible to relax the PST initiation prohibiting conditions, making it possible to avoid excessive suppression of PSTs.

### Further Example

Further example according to the present invention will be explained next. FIG. 8 is a block diagram illustrating a structure of a positioner 2 and a higher-level system 3 according to the present example, where structures identical to those of FIG. 4 are assigned identical codes. In the present example as well, the overall structure of the safety instrument system is identical to that of the Yet Another Example, and thus the explanation will use the codes of FIG. 6. In the Yet Another Example, evaluations as to whether or not to permit PST initiation were performed by positioners 2 individually. On the other hand, in the present example the higher-level system 3 acquires PST execution status information for the positioners 2 and flow rate measurement values for the flow rate measuring instruments 9, to evaluate, based on this information, whether or not the PST initiations are permitted. As with the Example, the present example envisions a case wherein a plurality of emergency cutoff valves is provided in the same system of pipes.

The higher-level system 3 includes a storing portion 30, a PST initiation instructing portion 31, a PST execution status acquiring portion 32, a PST initiation prohibition evaluating portion 33a, and a flow rate measurement value acquiring portion 34 for acquiring the flow rate measurement values for the process fluids from each of the flow rate measuring instruments 9 through each of the positioners 2. Each positioner 2 includes a PST executing portion 22a, a querying portion 23, and a flow rate measurement value acquiring portion 24.

In the present example, the flow of processes of the controlling device is identical to that in the Another Example, so FIG. 5 will be used to explain the operation of the safety instrument system according to the present example.

The processes in Step S200 and S201 of FIG. 5 are as were explained in the Another Example. The PST initiation prohibition evaluating portion 33a of the higher-level system 3, upon receipt of a query from a positioner 2, acquires PST execution status information from each of the positioners 2 through the PST execution status acquiring portion 32, acquires the flow rate measurement values from each of the flow rate measuring instruments 9 through the flow rate measurement value acquiring portions 24 of the individual positioners 2 and the flow rate measurement value acquiring portion 34 of the higher-level system 3, evaluates whether or not PST initiation is permitted for the positioner 2 that made the query, and sends the evaluation result to the positioner 2 that made the query (Step S202 in FIG. 5).

If there is a positioner 2 that is executing a PST, the PST initiation prohibition evaluating portion 33a checks the flow rate measurement values acquired from the individual flow rate measuring instruments 9, and if the current flow rate of the process fluid through the emergency cutoff valve 1 corresponding to the positioner 2 that made the query is outside of the specified range, sends a PST initiation prohibiting message. Moreover, when there is no other positioner 2 that is executing a PST, or if there is another positioner 2 that is executing a PST and the current flow rate of the process fluid that flows in the emergency cutoff valve 1 corresponding to a positioner 2 that made the query is within a specified range, the PST initiation prohibition evaluating portion 33a sends a PST initiation permitted message. The processes in Step S203 through S205 of FIG. 5 are as were explained in the Another Example.

Moreover, the PST initiation prohibition evaluating portion 33a references the schedule that is stored in the storing portion 30, and if the evaluation is that the PST initiation timing has been reached for a given emergency cutoff valve 1 (YES in Step S206 in FIG. 5), then, along with acquiring the PST execution statuses of the individual positioners 2 through the PST execution status acquiring portion 32, it acquires the flow rate measurement values from each of the flow rate measuring instruments 9 through the flow rate measured value acquiring portions 24 of the individual positioners 2 and the flow rate measurement value acquiring portion 34 of the higher-level system 3, to evaluate whether or not to permit the initiation of the PST on the emergency cutoff valve 1 (Step S207 in FIG. 5).

If a PST there is a positioner 2 that is executing a PST, the PST initiation prohibition evaluating portion 33a checks the flow rate measurement values acquired from each of the flow rate measuring instruments 9, and prohibits the initiation of the PST if the current flow rate of the process fluid that flows through the emergency cutoff valve 1 for which the PST initiation timing has arrived is outside of a specified range. Moreover, when there is no other positioner 2 that is executing a PST, or if there is another positioner 2 that is executing a PST and the current flow rate of the process fluid that flows in the emergency cutoff valve 1 for which the PST initiation timing has arrived, is within a specified range, the PST initiation prohibition evaluating portion 33a allows the PST initiation and instructs the PST initiation instructing portion 31 to send the PST initiating instruction signal. In response to this instruction, the PST initiation instructing portion 31 sends a PST initiating instruction signal to the positioner 2 corresponding to the emergency cutoff valve 1 that has reached the timing for initiating the PST.

As described above, as with the Yet Another Example, the present example makes it possible to relax the PST initiation prohibiting conditions, to thereby avoid excessive suppression of PSTs.

Note that while in the present example the flow rate measurement value for each individual flow rate measuring instrument 9 was obtained through the individual positioners 2, there is no limitation thereto, but rather the flow rate measurement values for the individual flow rate measuring instruments 9 may be obtained through another system, such as a DCS.

### Another Further Example

Another Further Example according to the present invention will be explained next. The Example, Another Example, Yet Another Example and Further Example envision cases wherein a plurality of emergency cutoff valves is provided in the same system of pipes. In contrast, the present example envisions a case wherein at least one of the plurality of emergency cutoff valves is provided in a different system of pipes. In the present example as well, the overall structure of the safety instrument system is identical to that of the Example, and thus the explanation will use the codes of FIG. 1. Moreover, the structure the positioner 2 and the higher-level system 3 is identical to that of the Another Example, and thus the explanation will use the codes of FIG. 4.

In the present example, the flow of processes of the controlling device is identical to that in the Another Example, so FIG. 5 will be used to explain the operation of the safety instrument system according to the present example.

The processes in Step S200 and S201 of FIG. 5 are as were explained in the Another Example. When a query is received from a positioner 2, the PST initiation prohibition evaluating portion 33 of the higher-level system 3 acquires PST execution status information for each of the positioners 2 through the PST execution status acquiring portion 32, and evaluates whether or not PST initiation is permitted for the positioner 2 that made the query, and sends the evaluation result to the positioner 2 that made the query (Step S202 in FIG. 5).

When there is another positioner 2 belonging to the same system of pipes as the positioner 2 that made the query and that is executing a PST, the PST initiation prohibition evaluating portion 33 sends a PST initiation prohibiting message, and if there is no other positioner 2, belonging to the same system of pipes of the positioner 2 that made the query and that is performing a PST, it sends a PST initiation permitting message. The PST initiation prohibition evaluating portion 33 stores in advance the correspondence relationships of the emergency cutoff valves 1 and the positioners 2 and the system of pipes, making it possible to evaluate whether or not PST initiation is permitted based on the correspondence relationships.

Moreover, the PST initiation prohibition evaluating portion 33 references the schedule that is stored in the storing portion 30, and if the evaluation is that the PST initiation timing has been reached for a given emergency cutoff valve 1 (YES in Step S206 in FIG. 5), it acquires the PST execution status information of the individual positioners 2 through the PST execution status acquiring portion 32, to evaluate whether or not to permit the initiation of the PST on the emergency cutoff valve 1 (Step S207 in FIG. 5).

If there is another positioner 2 is performing a PST and that belongs to the same system of pipes as the positioner 2 corresponding to the emergency cutoff valve 1 that has reached the PST initiation timing, the PST initiation prohibition evaluating portion 33 prohibits PST initiation. Moreover, if there is no other positioner 2, executing a PST, belonging to the same system of pipes as the positioner 2 corresponding to the emergency cutoff valve 1 for which the PST initiation timing has been reached, the PST initiation prohibition evaluating portion 33 permits the initiation of the PST, and instructs the PST initiation instructing portion 31 to send the PST initiating instruction signal. In response to this instruction, the PST initiation instructing portion 31 sends a PST initiating instruction signal to the positioner 2 corresponding to the emergency cutoff valve 1 that has reached the timing for initiating the PST.

In the present example, as described above, the addition of whether or not another positioner 2 belonging to the same system of pipes is executing a PST as an evaluation criterion, and permitting PST initiation when the positioner 2 for which the positioner 2 is attempting to initiate a PST belongs to a different system of pipes, even if another positioner 2 is executing a PST, makes it possible to relax the PST initiation prohibiting conditions, thus making it possible to avoid excessive suppression of PSTs.

FIG. 9(A) and FIG. 9(B) are diagrams illustrating an example of piping in the plant. FIG. 9 (A) illustrates a case wherein the flow path can be switched selectively from the pipe 8-1 to the pipe 8-2 or the pipe 8-3. In this case, the emergency cutoff valve 1-1 that is provided in the pipe 8-1 and the positioner 2-1 for controlling the emergency cutoff valve 1-1, belong to the same system of pipes as the emergency cutoff valve 1-2 that is provided in the pipe 8-2 and the positioner 2-2 for controlling the emergency cutoff valve 1-2, and the emergency cutoff valve 1-3 that is provided in the pipe 8-3 and the positioner 2-3 for controlling the emergency cutoff valve 1-3 also belong to the same system of pipes. On the other hand, the emergency cutoff valve 1-2 and the positioner 2-2 belong to a different system of pipes than the emergency cutoff valve 1-3 and the positioner 2-3.

FIG. 9 (B) illustrates a case wherein the flow path can be switched selectively from the pipe 8-6 to the pipe 8-4 or the pipe 8-5. In this case, the emergency cutoff valve 1-6 that is provided in the pipe 8-6 and the positioner 2-6 for controlling the emergency cutoff valve 1-6, belong to the same system of pipes as the emergency cutoff valve 1-4 that is provided in the pipe 8-4 and the positioner 2-4 for controlling the emergency cutoff valve 1-4, and the emergency cutoff valve 1-5 that is provided in the pipe 8-5 and the positioner 2-5 for controlling the emergency cutoff valve 1-5 also belong to the same system of pipes. On the other hand, the emergency cutoff valve 1-4 and the positioner 2-4 belong to a different system of pipes than the emergency cutoff valve 1-5 and the positioner 2-5.

Note that each of the positioners 2 and the higher-level systems 3 described in the Example, Another Example, Yet Another Example, Further Example and Another Further Example can each be embodied through a computer that includes a CPU (Central Processing Unit), a storage device, and an interface, along with a program for controlling these hardware resources. The CPUs for the individual devices execute the procedures described in the Example, Another Example, Yet Another Example, Further Example and Another Further Example following programs that are stored in the storage devices.

The present invention can be applied to partial stroke testing of emergency cutoff valves that are provided in order to prevent incidents in a plant.

1. A safety instrument system comprising:
a plurality of positioners that controls degrees of opening of a plurality of emergency cutoff valves that are provided in pipes in a plant; and
a higher-level system that controls PSTs of the emergency cutoff valves, wherein:
each positioner comprises:
a PST executing unit that executes a PST in the emergency cutoff valve in response to an initiating instruction from the higher-level system or an initiating instruction from an inputting device in a workplace wherein the positioner is provided;
a PST execution status acquiring unit that acquires PST execution status information for another positioner; and
a PST initiation prohibition evaluating unit that evaluates whether or not a PST initiation is permitted, based on a PST execution status of another positioner, when a PST initiating instruction has been received from the higher-level system or from the inputting device.

2. A safety instrument system comprising:
a plurality of positioners that controls degrees of opening of a plurality of emergency cutoff valves that are provided in pipes in a plant; and
a higher-level system for controlling PSTs of the emergency cutoff valves, wherein:
each positioner comprises:
a querying unit that queries the higher-level system as to whether or not PST initiation is permitted, when a PST initiating instruction has been received from the inputting device in a work area where in the positioner is provided; and
a PST executing unit that executes a PST in the emergency cutoff valve in response to an initiating instruction from the higher-level system and for executing a PST in the emergency cutoff valve through an initiating instruction from an inputting device in response to a PST initiation permitted/prohibited report from the higher-level system, wherein:
the higher-level system comprises:
a storage unit that stores a schedule for PSTs, established in advance;
a PST initiation instructing unit that sends, to the positioner, a PST initiating instruction following the schedule stored in the storage unit;
a PST execution status acquiring unit that acquires PST execution status information for each positioner; and
a PST initiation prohibition evaluating unit that evaluates whether or not to permit PST initiation based on the execution statuses of the PSTs of each of the positioners when there has been a query from a positioner as to whether or not PST initiation is permitted, reports to the positioner, and evaluates whether or not to permit PST initiation based on the execution statuses of the PSTs of each of the positioners when PST initiation timing has been reached based on the schedule, and, if PST initiation is permitted, instructs the PST initiation instructing unit to send a PST initiating instruction to the positioner.

3. A safety instrument system comprising:
a plurality of positioners that controls degrees of opening of a plurality of emergency cutoff valves that are provided in pipes in a plant;
a plurality of flow rate measuring instruments that measures flow rates of the process fluids that flow through the individual emergency cutoff valves; and
a higher-level system that controls PSTs of the emergency cutoff valves, wherein:
each positioner comprises:
a PST executing unit that executes a PST in the emergency cutoff valve in response to an initiating instruction from the higher-level system or an initiating instruction from an inputting device in the workplace wherein the positioner is provided;
a PST execution status acquiring unit that acquires PST execution status information for another positioner;
a flow rate measurement value acquiring unit that acquires the flow rate measurement value from the corresponding flow rate measuring instrument; and
a PST initiation prohibition evaluating unit that evaluates whether or not a PST initiation is permitted, based on a PST execution status of another positioner, and on the flow rate of the process fluid flowing through the corresponding emergency cutoff valve, when a PST initiating instruction has been received from the higher-level system or from the inputting device.

4. A safety instrument system comprising:
a plurality of positioners that controls degrees of opening of a plurality of emergency cutoff valves that are provided in pipes in a plant;
a plurality of flow rate measuring instruments that measures flow rates of the process fluids that flow through the individual emergency cutoff valves; and
a higher-level system that controls PSTs of the emergency cutoff valves, wherein:
each positioner comprises:
a querying unit that queries the higher-level system as to whether or not PST initiation is permitted, when a PST initiating instruction has been received from the inputting device in the work area where in the positioner is provided; and
a PST executing unit that executes a PST in the emergency cutoff valve in response to an initiating instruction from the higher-level system and for executing a PST in the emergency cutoff valve through an initiating instruction from an inputting device in response to a PST initiation permitted/prohibited report from the higher-level system, wherein:
the higher-level system comprises:
a storage unit that stores a schedule for PSTs, established in advance;
a PST initiation instructing unit that sends, to the positioner, a PST initiating instruction following the schedule stored in the storage unit;
a PST execution status acquiring unit that acquires PST execution status information for each positioner;
a flow rate measurement value acquiring unit that acquires flow rate measurement values from each of the flow rate measuring instruments; and
a PST initiation prohibition evaluating unit that evaluates whether or not to permit PST initiation based on the execution statuses of the PSTs of each of the positioners and the flow rate of the process fluid flowing through the emergency cutoff valve corresponding to the positioner that made the query when there has been a query from a positioner as to whether or not PST initiation is permitted, reports to the positioner, and evaluates whether or not to permit PST initiation based on the execution statuses of the PSTs of each of the positioners and the flow rate of the process fluid flowing through the emergency cutoff valve corresponding to the positioner that reached the PST initiation timing when PST initiation timing has been reached based on the schedule, and, if PST initiation is permitted, instructs the PST initiation instructing unit to send a PST initiating instruction to the positioner.

5. The safety instrument system as set forth in claim 2, wherein:
the higher-level system includes the PST initiation prohibition evaluating unit which, when there is a query from the positioner as to whether or not PST initiation is permitted, evaluates whether or not PST initiation is permitted based on the PST execution statuses of each of the positioners and on whether or not a positioner that is executing a PST belongs to the same system of pipes as the positioner of the query, and reports to the positioner, and when PST initiation timing based on the schedule has been reached, and the PST initiation prohibition evaluating unit which evaluates whether or not PST initiation is permitted based on the PST execution statuses of the individual positioners and on whether or not a positioner that is executing a PST belongs to the same system of pipes as the positioner corresponding to the emergency cutoff valve that has reached the PST initiation timing, and if PST initiation is permitted, instructs the PST initiation instructing unit to send a PST initiating instruction to the positioner.

6. A PST initiating method, including:
a PST initiation prohibition evaluating step for acquiring PST execution status information for other positioners and for evaluating whether or not a PST initiation is permitted, based on the PST execution statuses of the other positioners, when a PST initiating instruction has been received by a positioner, for controlling opening of an emergency cutoff valve that is provided in a pipe in a plant, from a higher-level system that manages PSTs on the emergency cutoff valve or from an inputting device on the plant floor wherein the positioner is provided; and
a PST executing step wherein the positioner executes a PST on the emergency cutoff valve when PST initiation is permitted.

7. A PST initiating method comprising:
a querying step for querying the higher-level system that manages PSTs on an emergency cutoff valve as to whether or not PST initiation is permitted, when a positioner that controls degree of opening of the emergency cutoff valve that is provided in a pipe in a plant has received a PST initiating instruction for the emergency cutoff valve from the inputting device in a work area where in the positioner is provided;
a PST executing step wherein the positioner executes a PST in the emergency cutoff valve in response to an initiating instruction from the higher-level system and for executing a PST in the emergency cutoff valve through an initiating instruction from an inputting device in response to a PST initiation permitted/prohibited report from the higher-level system;
a first PST initiation prohibition evaluating step for acquiring PST execution status information for other positioners, for evaluating whether or not a PST initiation is permitted, based on the PST execution statuses of the other positioners, and for reporting to the positioner, when there has been a query from the positioner as to whether or not PST initiation is permitted; and
a second PST initiation prohibition evaluating step wherein the higher-level system acquires PST execution status information for each of the positioners, evaluates whether or not PST initiation is permitted, based on the PST execution statuses of the individual positioners, and, if PST initiation is permitted, sends a PST initiating instruction to the positioner, if timing for a PST initiation has been reached based on the schedule.

8. A PST initiating method comprising:
a PST initiation prohibition evaluating step for acquiring PST execution status information for other positioners and for acquiring a flow rate measurement value from a flow rate measuring instrument for measuring a flow rate of a process fluid through a corresponding emergency cutoff valve, and for evaluating whether or not a PST initiation is permitted, based on the PST execution statuses of the other positioners and on a flow rate of a process fluid through a corresponding emergency cutoff valve, when a PST initiating instruction has been received by a positioner, for controlling the opening of an emergency cutoff valve that is provided in a pipe in a plant, from a higher-level system that manages PSTs on the emergency cutoff valve or from an inputting device on the plant floor wherein the positioner is provided; and
a PST executing step wherein the positioner executes a PST on the emergency cutoff valve when PST initiation is permitted.

9. A PST initiating method comprising:
a querying step for querying the higher-level system that manages PSTs on the emergency cutoff valve as to whether or not PST initiation is permitted, when the positioner that controls the degree of opening of the emergency cutoff valve that is provided in a pipe in a plant has received a PST initiating instruction for the emergency cutoff valve from the inputting device in the work area where in the positioner is provided;
a PST executing step wherein the positioner executes a PST in the emergency cutoff valve in response to an initiating instruction from the higher-level system and for executing a PST in the emergency cutoff valve through an initiating instruction from an inputting device in response to a PST initiation permitted/prohibited report from the higher-level system;
a first PST initiation prohibition evaluating step for acquiring PST execution status information for other positioners and for acquiring a flow rate measurement value from a flow rate measuring instrument for measuring a flow rate of a process fluid through a corresponding emergency cutoff valve, and for evaluating whether or not a PST initiation is permitted, based on the PST execution statuses of the other positioners and on a flow rate of a process fluid through a corresponding emergency cutoff valve, and for reporting to the positioner, when there has been a query from the positioner as to whether or not PST initiation is permitted; and
a second PST initiation prohibition evaluating step for acquiring PST execution status information for other positioners and for acquiring a flow rate measurement value from a flow rate measuring instrument for measuring a flow rate of a process fluid through a corresponding emergency cutoff valve, for evaluating whether or not a PST initiation is permitted, based on the PST execution statuses of the other positioners and on a flow rate of a process fluid through an emergency cutoff valve for which the PST initiation timing has been reached, and for sending, to the positioner, a PST initiating instruction if PST initiation is permitted, when a PST initiation timing has been reached based on a schedule.

10. The PST initiating method as set forth in claim 7, wherein:
the first PST initiation prohibition evaluating step, when there has been a query from the positioner as to whether or not PST initiation is permitted, evaluates whether or not a PST initiation is permitted, based on the PST execution statuses of each of the positioners and on whether or not a positioner that is executing a PST belongs to the same system of pipes as the positioner that made the query, and reports to the positioner; and
the second PST initiation prohibition evaluating step, if timing for a PST initiation has been reached based on the schedule, evaluates whether or not PST initiation is permitted based on the PST execution statuses of the individual positioners and on whether or not a positioner that is executing a PST belongs to the same system of pipes as the positioner corresponding to the emergency cutoff valve for which the PST initiation timing has been reached, and, if PST initiation is permitted, sends a PST initiating instruction to the positioner.
